(19) United States
(12) Patent Application Publication
(10) Pub. No.: US 2025/0087072 A1
(43) Pub. Date: Mar. 13, 2025

(54) Fire Prevention Assembly

(71) Applicant: Robert Olsen, San Francisco, CA (US)

(72) Inventor: Robert Olsen, San Francisco, CA (US)

(21) Appl. No.: 18/243,542

(22) Filed: Sep. 7, 2023

(51) Int. Cl. G08B 17/10; G08B 7/06; H02H 5/00

(52) U.S. Cl. CPC G08B 17/10; G08B 7/06; H02H 5/00

(57) ABSTRACT

A fire prevention assembly includes a smoke detector that is strategically positioned in a building to detect smoke in the building. The smoke detector includes a broadcast unit which broadcasts a shutdown signal when the smoke detector detects smoke. A breaker panel is provided and a communication unit is integrated into the breaker panel. The communication unit is in remote communication with the broadcast unit in the smoke detector. The breaker panel is de-actuated when the communication unit receives the shutdown signal such that the breaker panel turns off the electrical appliances to inhibit a fire associated with any of the electrical appliances from developing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire prevention devices and more particularly pertains to a new fire prevention device for inhibiting an incipient fire from developing. The device includes a smoke detector and a broadcast unit integrated into the smoke detector which broadcasts a shutdown signal. The device includes a breaker panel and a communication unit integrated into the breaker panel which receives the shutdown signal from the broadcast unit. The breaker panel turns off kitchen appliances when the communication unit receives the shutdown signal to inhibit an incipient fire associated with one of the kitchen appliances from developing.

### (2) Description of Related Art including Information Disclosed Under 37 CFR 1.97 and 1.98

The prior art relates to fire prevention devices including a variety of smoke detector devices that are in wireless communication with various electric appliances for turning off the electrical appliances when the smoke detector detects smoke. In no instance does the prior art disclose a smoke detector with a broadcast unit and a breaker panel with a communication unit that receives a shutdown signal from the broadcast unit for turning off kitchen appliances.

### BRIEF SUMMARY OF THE INVENTION

An embodiment of the disclosure meets the needs presented above by generally comprising a smoke detector that is strategically positioned in a building to detect smoke in the building. The smoke detector includes a broadcast unit which broadcasts a shutdown signal when the smoke detector detects smoke. A breaker panel is provided and a communication unit is integrated into the breaker panel. The communication unit is in remote communication with the broadcast unit in the smoke detector. The breaker panel is de-actuated when the communication unit receives the shutdown signal such that the breaker panel turns off the electrical appliances to inhibit a fire associated with any of the electrical appliances from developing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a fire prevention assembly according to an embodiment of the disclosure.

FIG. 2 is a back perspective view of an embodiment of the disclosure.

FIG. 3 is a schematic view of an embodiment of the disclosure.

FIG. 4 is a perspective in-use view of an embodiment of the disclosure.

### DETAILED DESCRIPTION OF THE INVENTION

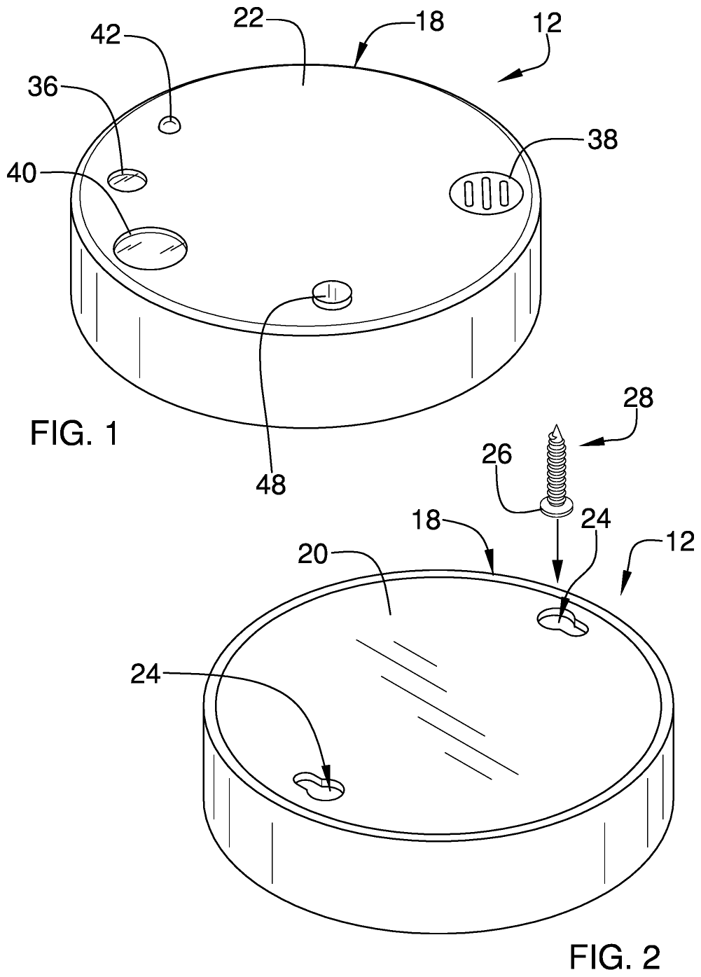

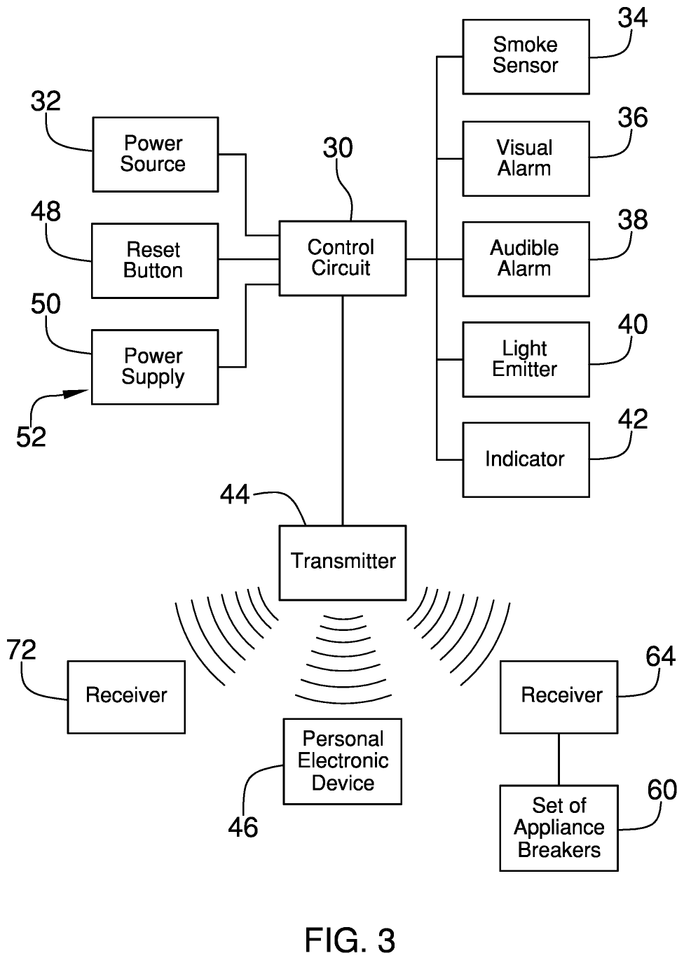

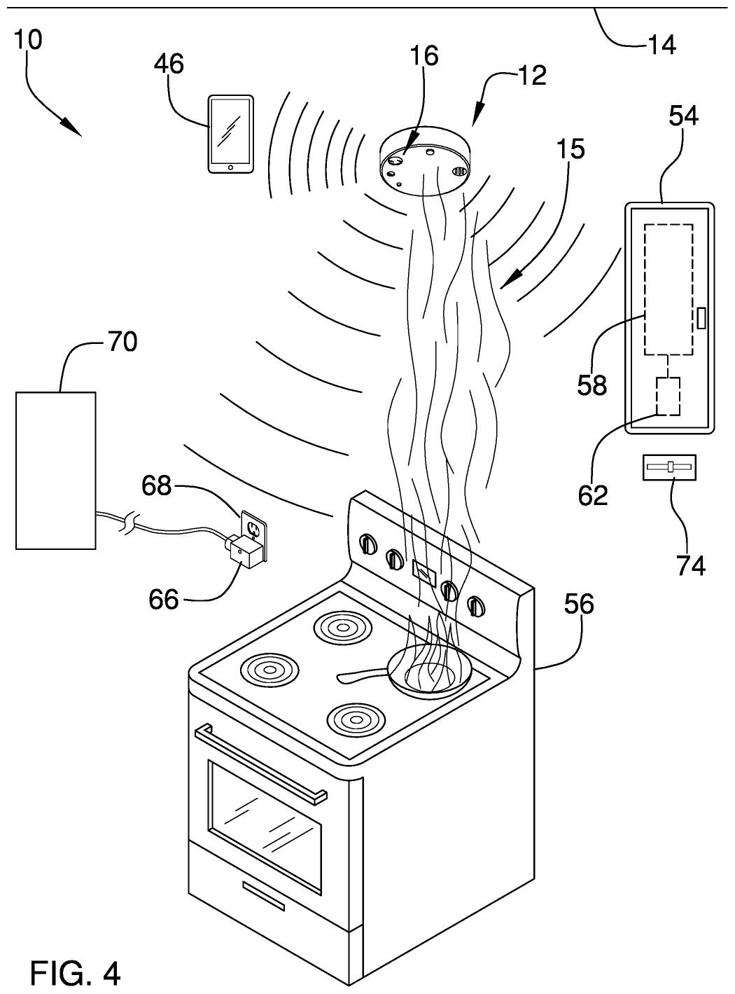

With reference now to the drawings, and in particular to FIGS. 1 through 4 thereof, a new fire prevention device embodying the principles and concepts of an embodiment of the disclosure and generally designated by the reference numeral 10 will be described.

As best illustrated in FIGS. 1 through 4, the fire prevention assembly 10 generally comprises a smoke detector 12 that is strategically positioned in a building 14 to detect smoke 15 in the building 14. The building 14 may be a house, an apartment or any other type of occupancy that typically has a kitchen. The smoke detector 12 includes a broadcast unit 16 which broadcasts a shutdown signal when the smoke detector 12 detects smoke 15. The smoke detector 12 comprises a housing 18 which has a rear wall 20 and a front wall 22; the housing 18 has a plurality of fasteners wells 24 each extending into the rear wall 20 thereby facilitating each of the fastener wells 24 to receive a head 26 of a fastener 28 for mounting the housing 18 to a surface in the building 14. A control circuit 30 is positioned in the housing 18 and the control circuit 30 receives an alert input. The control circuit 30 is electrically coupled to a power source 32 comprising an electrical system of the building 14.

A smoke sensor 34 is integrated into the front wall 22 of the housing 18 to sense smoke 15 that contacts the housing 18. The smoke sensor 34 is electrically coupled to the control circuit 30 and the control circuit 30 receives the alert input when the smoke sensor 34 senses smoke 15. The smoke detector 12 may be an electronic smoke detector 12 of any conventional design, including an ionization detector, a photoelectric detector or a dual detector. A visual alarm 36 is integrated into the front wall 22 of the housing 18 such that the visual alarm 36 is visible to an occupant of the building 14. The visual alarm 36 is electrically coupled to the control circuit 30 and the visual alarm 36 is actuated to emit a visible alert when the control circuit 30 receives the alert input to visually alert the occupant that smoke 15 has been detected. The visual alarm 36 may comprise a light emitting diode or the like that repeatedly flashes on and off like a strobe.

An audible alarm 38 is integrated into the front wall 22 of the housing 18 to emit an audible alert from the housing 18 and the audible alarm 38 is electrically coupled to the control circuit 30. The audible alarm 38 is actuated to emit an audible alert when the control circuit 30 receives the alert input to audibly alert the occupant that smoke 15 has been detected. The audible alarm 38 may comprise an electronic speaker or other similar type of device. A light emitter 40 is integrated into the front wall 22 of the housing 18 to emit light outwardly from the housing 18 and the light emitter 40 is electrically coupled to the control circuit 30. The light emitter 40 is turned on when the control circuit 30 receives the alert input to ensure the occupants can see to exit the building 14. The light emitter 40 may comprise a light emitting diode or other type of electronic light emitter.

An indicator 42 is integrated into the front wall 22 of the housing 18 such that the indicator 42 is visible to the occupants of the building 14 and the indicator 42 is electrically coupled to the control circuit 30. The indicator 42 is turned on when the control circuit 30 receives electrical power to alert the occupant that the smoke detector 12 is functional. A transmitter 44 is integrated into the housing 18 and the transmitter 44 is electrically coupled to the control circuit 30. The transmitter 44 broadcasts the shutdown signal when the control circuit 30 receives the alert input such that the transmitter 44 defines the broadcast unit 16. The transmitter 44 is in wireless communication with a personal electronic device 46 thereby facilitating the personal electronic device 46 to be notified when the smoke detector 12 detects smoke 15. In this way the transmitter 44 can remotely alert the owner of the personal electronic device 46 to the smoke 15 in the building 14. The transmitter 44 may comprise a radio frequency transmitter or the like and the personal electronic device 46 may comprise a smart phone or other type of device with wireless communication capabilities.

A reset button 48 is movably integrated into the front wall 22 of the housing 18 and the reset button 48 is electrically coupled to the control circuit 30. The reset button 48 resets the control circuit 30 when the reset button 48 is depressed for de-actuating each of the visual alarm 36, the audible alarm 38, the light emitter 40, the indicator 42 and the transmitter 44. A power supply 50 is integrated into the housing 18 and the power supply 50 is electrically coupled to the control circuit 30. The power supply 50 comprises at least one battery 52 and the at least one battery 52 supplies back up electrical power to the control circuit 30 in the event of a power outage in the building 14.

A breaker panel 54 is provided and the breaker panel 54 is integrated into the building 14. The breaker panel 54 is in electrical communication with electrical appliances 56 in the building 14 and the breaker panel 54 has a plurality of circuit breakers 58. The plurality of circuit breakers 58 includes a set of appliance breakers 60 and each of the set of appliance breakers 60 is in electrical communication with a respective one of the electrical appliances 56 in the building 14. Furthermore, the breaker panel 54 may be a breaker panel of any conventional design that complies with the National Electrical Code employed in the United States.

A communication unit 62 is integrated into the breaker panel 54 and the communication unit 62 is in remote communication with the broadcast unit 16 in the smoke detector 12. The communication unit 62 receives the shutdown signal from the broadcast unit 16 and the breaker panel 54 is de-actuated when the communication unit 62 receives the shutdown signal. In this way the breaker panel 54 turns off the electrical appliances 56 to inhibit a fire associated with any of the electrical appliances 56 from developing. The communication unit 62 comprises a receiver 64 that is integrated into the breaker panel 54 and the receiver 64 is electrically coupled to each of the set of appliance breakers 60. The receiver 64 is in wireless communication with the transmitter 44 such that the receiver 64 receives the shutdown signal from the transmitter 44. Each of the set of appliance breakers 60 is turned off when the receiver 64 receives the shutdown signal from the transmitter 44. Additionally, the receiver 64 may comprise a radio frequency receiver or the like and the receiver 64 may include a switching element for turning off the set of appliance breakers 60. Alternatively, the broadcast unit 16 may be hard wired to the communication unit 62.

A plurality of appliance power supplies 66 is provided and each of the plurality of appliance power supplies 66 is plugged into a female electrical outlet 68 in the building 14 for supplying electrical power to an associated electrical appliance 70. Each of the plurality of appliance power supplies 66 is in remote communication with the broadcast unit 16 such that each of the plurality of appliance power supplies 66 receives the shutdown signal from the broadcast unit 16. In this way each of the plurality of appliance power supplies 66 is turned off when the plurality of appliance power supplies 66 receives the shutdown signal for turning off the associated electrical appliance 70.

Each of the plurality of appliance power supplies 66 includes a receiver 72 that is in wireless communication with the transmitter 44 in the smoke detector 12. The receiver 72 associated with each of the plurality of appliance power supplies 66 receives the shutdown signal from the transmitter 44. Furthermore, each of the plurality of appliance power supplies 66 is turned off when the receiver 64 associated with each of the plurality of appliance power supplies 66 receives the shutdown signal. In this way the plurality of appliance power supplies 66 inhibit a fire associated with any of the associated electrical appliances 56 from developing. The receiver 72 associated with each of the appliance power supplies 66 may comprise a radio frequency receiver or the like. As is shown in FIG. 4, a gas flow valve 74 may be integrated into a gas line which services a gas stove. The gas flow valve 74 may be in wireless communication with the transmitter 44 and the gas flow valve 74 may be turned off when the transmitter 44 broadcasts the shutdown signal thereby disabling the gas stove.

In use, the transmitter 44 in the smoke detector 12 broadcasts the shutdown signal when the smoke sensor 34 senses smoke 15. Furthermore, the audible alarm 38, the visual alarm 36 and the light emitter 40 are each actuated when the smoke sensor 34 senses smoke 15. The set of appliance breakers 60 is turned off when the transmitter 44 broadcasts the shutdown signal to turn off the electrical appliances 56 in the kitchen. In this way an incipient fire in a cooking pot on a stove, for example, can be inhibited from becoming a fully developed fire. Furthermore, each of the appliance power supplies 66 is shut down when the transmitter 44 broadcasts the shutdown signal. The transmitter 44 broadcasts a reset signal when the reset button 48 on the smoke detector 12 is depressed to re-actuate the set of appliance breakers 60 and the plurality of appliance power supplies 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A fire prevention assembly for killing power to kitchen appliances when smoke is detected, said assembly comprising:
a smoke detector being strategically positioned in a building wherein said smoke detector is configured to detect smoke in said building, said smoke detector including a broadcast unit which broadcasts a shutdown signal when said smoke detector detects smoke;
a breaker panel being integrated into said building, said breaker panel being in electrical communication with electrical appliances in said building, said breaker panel having a plurality of circuit breakers;
a communication unit being integrated into said breaker panel, said communication unit being in remote communication with said broadcast unit in said smoke detector, said communication unit receiving said shutdown signal from said broadcast unit, said breaker panel being de-actuated when said communication unit receives said shutdown signal such that said breaker panel turns off said electrical appliances wherein said breaker panel is configured to inhibit a fire associated with any of said electrical appliances from developing; and
a plurality of appliance power supplies, each of said plurality of appliance power supplies being plugged into a female electrical outlet in said building for supplying electrical power to an associated electrical appliance, each of said plurality of appliance power supplies being in remote communication with said broadcast unit such that each of said plurality of appliance power supplies receives said shutdown signal from said broadcast unit, each of said plurality of appliance power supplies being turned off when said plurality of appliance power supplies receives said shutdown signal for turning off said associated electrical appliance;
wherein said smoke detector comprises a housing having a rear wall and a front wall, said housing having a plurality of fasteners wells each extending into said rear wall thereby facilitating each of said fastener wells to receive a head of a fastener for mounting said housing to a surface in said building spaced above a potential source of the smoke.

2. The assembly according to claim 1, wherein said smoke detector comprises:
a control circuit being positioned in said housing, said control circuit receiving an alert input, said control circuit being electrically coupled to a power source comprising an electrical system of said building;
a smoke sensor being integrated into said front wall of said housing wherein said smoke sensor is configured to sense smoke that contacts said housing, said smoke sensor being electrically coupled to said control circuit, said control circuit receiving said alert input when said smoke sensor senses smoke;
a visual alarm being integrated into said front wall of said housing wherein said visual alarm is configured to be visible to an occupant of said building, said visual alarm being electrically coupled to said control circuit, said visual alarm being actuated to emit a visible alert when said control circuit receives said alert input wherein said visual alarm is configured to visually alert the occupant that smoke has been detected;
an audible alarm being integrated into said front wall of said housing wherein said audible alarm is configured to emit an audible alert from said housing, said audible alarm being electrically coupled to said control circuit, said audible alarm being actuated to emit an audible alert when said control circuit receives said alert input wherein said audible alarm is configured to audibly alert the occupant that smoke has been detected;
a light emitter being integrated into said front wall of said housing wherein said light emitter is configured to emit light outwardly from said housing, said light emitter being electrically coupled to said control circuit, said light emitter being turned on when said control circuit receives said alert input wherein said light emitter is configured to ensure the occupants can see to exit said building;
an indicator being integrated into said front wall of said housing wherein said indicator is configured to be visible to the occupants of said building, said indicator being electrically coupled to said control circuit, said indicator being turned on when said control circuit receives electrical power wherein said indicator is configured to alert the occupant that said smoke detector is functional;
a transmitter being integrated into said housing, said transmitter being electrically coupled to said control circuit, said transmitter broadcasting said shutdown signal when said control circuit receives said alert input such that said transmitter defines said broadcast unit, said transmitter being in wireless communication with a personal electronic device thereby facilitating said personal electronic device to be notified when said smoke detector detects smoke wherein said transmitter is configured to remotely alert the owner of the personal electronic device to the smoke in said building;
a reset button being movably integrated into said front wall of said housing, said reset button being electrically coupled to said control circuit, said reset button resetting said control circuit when said reset button is depressed for de-actuating each of said visual alarm and said audible alarm and said light emitter and said indicator and said transmitter; and
a power supply being integrated into said housing, said power supply being electrically coupled to said control circuit, said power supply comprising at least one battery, said at least one battery supplying back up electrical power to said control circuit in the event of a power outage in said building.

3. The assembly according to claim 2, wherein:
said plurality of circuit breakers includes a set of appliance breakers, each of said set of appliance breakers being in electrical communication with a respective one of said electrical appliances in said building; and
said communication unit comprises a receiver being integrated into said breaker panel, said receiver being electrically coupled to each of said set of appliance breakers, said receiver being in wireless communication with said transmitter such that said receiver receives said shutdown signal from said transmitter, each of said set of appliance breakers being turned off when said receiver receives said shutdown signal from said transmitter.

4. The assembly according to claim 2, wherein each of said plurality of appliance power supplies includes a receiver being in wireless communication with said transmitter in said smoke detector, said receiver associated with each of said plurality of appliance power supplies receiving said shutdown signal from said transmitter, each of said plurality of appliance supplies being turned off when said receiver associated with each of said plurality of appliance power supplies receives said shutdown signal wherein said plurality of appliance power supplies is configured to inhibit a fire associated with any of said associated electrical appliances from developing.

5. A fire prevention assembly for killing power to kitchen appliances when smoke is detected, said assembly comprising:
a smoke detector being strategically positioned in a building wherein said smoke detector is configured to detect smoke in said building, said smoke detector including a broadcast unit which broadcasts a shutdown signal when said smoke detector detects smoke, said smoke detector comprising:
a housing having a rear wall and a front wall, said housing having a plurality of fasteners wells each extending into said rear wall thereby facilitating each of said fastener wells to receive a head of a fastener for mounting said housing to a surface in said building spaced above a potential source of the smoke;
a control circuit being positioned in said housing, said control circuit receiving an alert input, said control circuit being electrically coupled to a power source comprising an electrical system of said building;
a smoke sensor being integrated into said front wall of said housing wherein said smoke sensor is configured to sense smoke that contacts said housing, said smoke sensor being electrically coupled to said control circuit, said control circuit receiving said alert input when said smoke sensor senses smoke;
a visual alarm being integrated into said front wall of said housing wherein said visual alarm is configured to be visible to an occupant of said building, said visual alarm being electrically coupled to said control circuit, said visual alarm being actuated to emit a visible alert when said control circuit receives said alert input wherein said visual alarm is configured to visually alert the occupant that smoke has been detected;
an audible alarm being integrated into said front wall of said housing wherein said audible alarm is configured to emit an audible alert from said housing, said audible alarm being electrically coupled to said control circuit, said audible alarm being actuated to emit an audible alert when said control circuit receives said alert input wherein said audible alarm is configured to audibly alert the occupant that smoke has been detected;
a light emitter being integrated into said front wall of said housing wherein said light emitter is configured to emit light outwardly from said housing, said light emitter being electrically coupled to said control circuit, said light emitter being turned on when said control circuit receives said alert input wherein said light emitter is configured to ensure the occupants can see to exit said building;
an indicator being integrated into said front wall of said housing wherein said indicator is configured to be visible to the occupants of said building, said indicator being electrically coupled to said control circuit, said indicator being turned on when said control circuit receives electrical power wherein said indicator is configured to alert the occupant that said smoke detector is functional;
a transmitter being integrated into said housing, said transmitter being electrically coupled to said control circuit, said transmitter broadcasting said shutdown signal when said control circuit receives said alert input such that said transmitter defines said broadcast unit, said transmitter being in wireless communication with a personal electronic device thereby facilitating said personal electronic device to be notified when said smoke detector detects smoke wherein said transmitter is configured to remotely alert the owner of the personal electronic device to the smoke in said building;
a reset button being movably integrated into said front wall of said housing, said reset button being electrically coupled to said control circuit, said reset button resetting said control circuit when said reset button is depressed for de-actuating each of said visual alarm and said audible alarm and said light emitter and said indicator and said transmitter; and
a power supply being integrated into said housing, said power supply being electrically coupled to said control circuit, said power supply comprising at least one battery, said at least one battery supplying back up electrical power to said control circuit in the event of a power outage in said building;
a breaker panel being integrated into said building, said breaker panel being in electrical communication with electrical appliances in said building, said breaker panel having a plurality of circuit breakers, said plurality of circuit breakers including a set of appliance breakers, each of said set of appliance breakers being in electrical communication with a respective one of said electrical appliances in said building;
a communication unit being integrated into said breaker panel, said communication unit being in remote communication with said broadcast unit in said smoke detector, said communication unit receiving said shutdown signal from said broadcast unit, said breaker panel being de-actuated when said communication unit receives said shutdown signal such that said breaker panel turns off said electrical appliances wherein said breaker panel is configured to inhibit a fire associated with any of said electrical appliances from developing, said communication unit comprising a receiver being integrated into said breaker panel, said receiver being electrically coupled to each of said set of appliance breakers, said receiver being in wireless communication with said transmitter such that said receiver receives said shutdown signal from said transmitter, each of said set of appliance breakers being turned off when said receiver receives said shutdown signal from said transmitter; and
a plurality of appliance power supplies, each of said plurality of appliance power supplies being plugged into a female electrical outlet in said building for supplying electrical power to an associated electrical appliance, each of said plurality of appliance power supplies being in remote communication with said broadcast unit such that each of said plurality of appliance power supplies receives said shutdown signal from said broadcast unit, each of said plurality of appliance power supplies being turned off when said plurality of appliance power supplies receives said shutdown signal for turning off said associated electrical appliance, each of said plurality of appliance power supplies including a receiver being in wireless communication with said transmitter in said smoke detector, said receiver associated with each of said plurality of appliance power supplies receiving said shutdown signal from said transmitter, each of said plurality of appliance supplies being turned off when said receiver associated with each of said plurality of appliance power supplies receives said shutdown signal wherein said plurality of appliance power supplies is configured to inhibit a fire associated with any of said associated electrical appliances from developing.
